(19) United States
(12) Patent Application Publication
(10) Pub. No.: US 2006/0265755 A1
(43) Pub. Date: Nov. 23, 2006

(54) Method And Related Apparatus For Enhancing Information Security Of A Computer System

(76) Inventor: Ta-Wei Liu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/160,424

(22) Filed: Jun. 23, 2005

(30) Foreign Application Priority Data
May 18, 2005 (TW) 094116114

(51) Int. Cl. H04N 7/16

(52) U.S. Cl. 726/26

(57) ABSTRACT

A method for enhancing information security of a computer system for starting the computer system securely includes receiving radio frequency identification data when the computer system is switched on and controlling a power system of the computer system according to the radio frequency identification data.

### BACKGROUND OF THE INVENTION

1. Field of the Invention

The present invention provides a method for enhancing information security of a computer system, and more particularly, a method for determining an operating status of the computer system according to radio frequency identification data.

2. Description of the Prior Art

The popularization of computer systems brings about fast and convenient information networks. With computer systems, people can handle a lot of data efficiently, causing more and more enterprises to adopt computer systems for implementing electronic offices. Therefore, information security becomes more important.

If a user wants to use a computer system, the user must turn on a power switch. After completing a start process, the computer system is available. In order to identify different users and maintain information security, before entering an operating system, the user must key in a username and a password. Then, according to different users, the operating system provides different services. Therefore, the computer system can manage user's data and maintain information security. Especially for a public use computer system, information security is much more important. For example, in a company, a computer system may store a lot of confidential documents or data, and only some users with special authorization can access the computer system for keeping the confidential documents from being lost. However, since the computer system checks the username and the password only before entering the operating system, a user can enter the operating system to access data if the user has a username and a corresponding password. Moreover, some back door software can jump over the operating system to access data stored in the computer system. In short, the prior art computer system does not check user's data when the computer system is turned on, causing a weak point in information security.

In addition, after a duration of not using the computer system, the operating system can switch the computer system to a standby mode or a sleep mode to save power, and go back to a previous state, or wake the computer system up, when the computer system is reused. In order to maintain information security, the computer system can request a user to key in a username and a password when being woken up. However, anyone can enter the operating system if he/she gets a username and a corresponding password. Therefore, data stored in the computer system may be lost if someone steals an available username and a password.

### SUMMARY OF THE INVENTION

It is therefore a primary objective of the claimed invention to provide methods and related apparatuses for enhancing information security of a computer system.

The present invention discloses a method for enhancing information security of a computer system for starting the computer system securely. The method includes: receiving radio frequency identification data when the computer system is switched on; and controlling a power system of the computer system according to the radio frequency identification data.

The present invention further discloses a computer system capable of enhancing information security, which includes a basic input and output system for performing basic input and output functions of the computer system; a power switch for signaling the basic input and output system for starting the computer system; a power system coupled to the basic input and output system for outputting power; a radio frequency identification data receiver for receiving radio frequency identification data; and a decision module for controlling the power system through the basic input and output system according to the radio frequency identification data received by the radio frequency identification data receiver when the power switch is switched on.

The present invention further discloses a method for enhancing information security of a computer system for waking up a computer system operating in a standby mode. The method includes: receiving radio frequency identification data; and determining an operating mode of the computer system according to the radio frequency identification data.

The present invention further discloses a computer system capable of enhancing information security, which includes a basic input and output system for performing basic input and output functions of the computer system; a power system coupled to the basic input and output system for outputting power; a radio frequency identification data receiver for receiving radio frequency identification data; an operating system for performing functions of the computer system; and an operating mode control software for controlling the power system and an operating mode of the operating system according the radio frequency identification data received by the radio frequency identification data receiver when the computer system is in a standby mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 illustrate flowcharts of processes for starting a computer system safely in accordance with the present invention.

FIG. 3 illustrates a block diagram of a computer system capable of enhancing information security in accordance with the present invention.

FIG. 4 and FIG. 5 illustrate flowcharts of processes for waking up a computer system operating in a standby mode safely in accordance with the present invention.

FIG. 6 illustrates a block diagram of a computer system capable of enhancing information security in accordance with the present invention.

### DETAILED DESCRIPTION

Radio frequency identification (RFID) system is a contact-free automatic identification system, and can be used in all kinds of adverse circumstances. The RFID system has advantages of contact-free reading, the capability of being updated, a large data capacity, the capability of being reused, high security, and a small volume. The present invention utilizes a RFID system in a computer system for maintaining information security of the computer system.

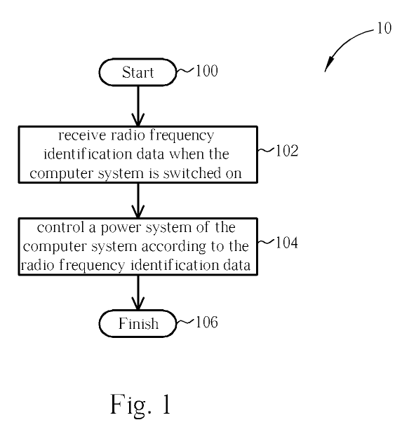

Please refer to FIG. 1, which illustrates a flowchart of a process 10 in accordance with the first embodiment of the present invention. The process 10 is used for starting a computer system safely, and includes following steps:

Step 100: start;

Step 102: receive radio frequency identification data when the computer system is switched on;

Step 104: control a power system of the computer system according to the radio frequency identification data;

Step 106: finish.

Therefore, when a user presses a power switch of the computer system, the present invention process 10 determines whether the user has authorization to use the computer system according to the RFID data of the user, and controls the power system of the computer system. For example, if the RFID data indicates that the user has authorization to use the computer system, then the present invention can enable the power system through a basic input and output system (BIOS) of the computer system, and perform a following start process. Oppositely, if the RFID data indicates that the user does not have authorization to use the computer system, then the present invention can output an alarm signal through a monitor or speakers, and disable the power system, so as to stop the following start process.

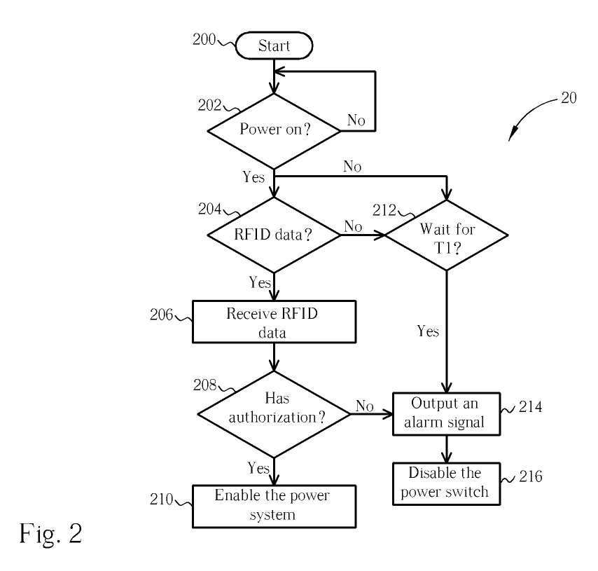

Please refer to FIG. 2, which illustrates a flowchart of a process 20 in accordance with the second embodiment of the present invention. The process 20 is used for starting a computer system safely, and includes following steps:

Step 200: start.

Step 202: determine whether a power switch of the computer system is switched on or not. If the power switch is switched on, then go to step 204, otherwise, stay in the initial state.

Step 204: determine whether there is RFID data to be received or not. If there is RFID data to be received, then go to step 206, otherwise, go to step 212.

Step 206: receive the RFID data.

Step 208: determine whether the received RFID data has a specific authorization or not. If the RFID data has the specific authorization, then go to step 210, otherwise, go to step 214.

Step 210: enable a power system of the computer system through a BIOS of the computer system, so as to perform the following start process.

Step 212: determine whether a duration of waiting for receiving the RFID data is greater than a default time duration T1 or not. If the duration of waiting for receiving the RFID data is greater than T1, then go to step 214, otherwise, keep waiting for receiving the RFID data and go back to step 204.

Step 214: output an alarm signal through an output module of the computer system to indicate that the user does not have authorization to use the computer system, and go to step 216.

Step 216: disable the power system.

According to the process 20, after a user presses the power switch of the computer system, the present invention tries to receive RFID data first. If the RFID data cannot be received immediately, then the process 20 waits for the default duration T1. If the RFID data still cannot be received after the duration T1, then the process 20 determines that there is no RFID data to be received, and outputs the alarm signal and goes back to the initial state. Oppositely, if the RFID data is received, then the process 20 determines whether the RFID data is authorization or not. If the RFID data is authorized, then the process 20 enables the power system to perform the start process, and if the RFID data does not have authorization, meaning that the user is not a legal user, then the process 20 outputs the alarm signal and goes back to the initial state, so as to prevent data stored in the computer system from being accessed.

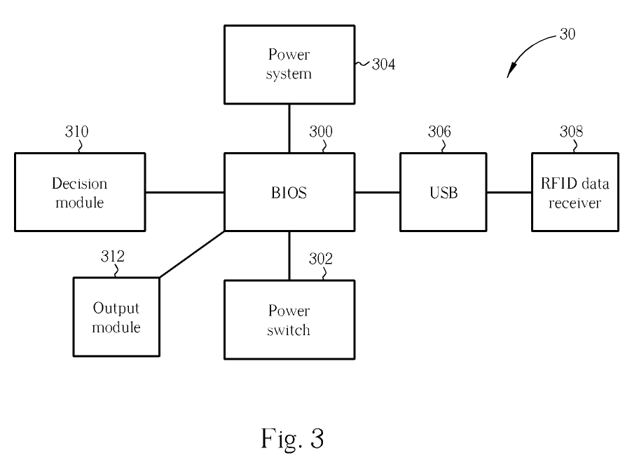

Therefore, before the computer system enters an operating system, the process 20 determines whether the user is an authorized user or not. Even if a username and corresponding password are stolen, the computer system still prevents data from being lost. In the present invention, the computer system can receive the RFID data through a universal serial bus (USB) port. For example, please refer to FIG. 3, which illustrates a block diagram of a computer system 30 capable of enhancing information security in accordance with the third embodiment of the present invention. The computer system 30 implements the process 20, and includes a BIOS 300, a power switch 302, a power system 304, a USB 306, a RFID data receiver 308, a decision module 310, and an output module 312. When a user presses the power switch 302 to switch on the computer system 300, the BIOS 300 receives RFID data of the user through the USB 306 from the RFID data receiver 308. According to the received RFID data, the decision module 310 can enable the power system 304 through the BIOS 300, or output an alarm signal through the BIOS 300 from the output module 312.

Therefore, the computer system 30 can prevent data lost owing to a stolen password, so as to enhance information security.

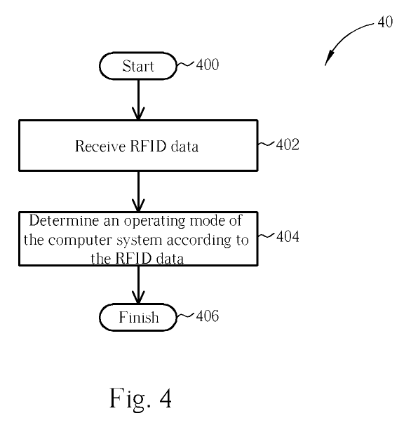

In addition, as mentioned above, a computer system, operating in a standby mode, requests a user to key in a username and a password when being waken up, so that anyone can enter the operating system of the computer system if he/she gets a username and a corresponding password. Therefore, the present invention further provides a method for enhancing information security. Please refer to FIG. 4, which illustrates a flowchart of a process 40 in accordance with the fourth embodiment of the present invention. The process 40 is used to wake up a computer system operating in a standby mode safely, and includes following steps:

Step 400: start.

Step 402: receive RFID data.

Step 404: determine an operating mode of the computer system according to the RFID data.

Step 406: finish.

Therefore, the process 40 determines whether a user has authorization to use the computer system or not according to the RFID data of the user, and changes the operating mode of the computer system. For example, if the RFID data indicates that the user has authorization to user the computer system, then the present invention wakes up the computer system through software stored in the computer system, so as to go back to the previous state before entering the standby mode. Oppositely, if the RFID data indicates that the user does not have authorization to user the computer system, then the present invention outputs an alarm signal through a monitor or speakers of the computer system, and keeps the computer system in the standby mode. In short, the process 40 is similar to the process 10. The process 40 is able to determine when to wake up a computer system operating in a standby mode, while the process 10 is able to determine when to enable the power system of the computer system.

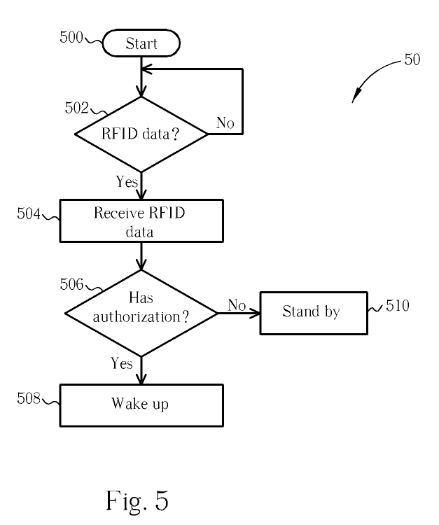

Please refer to FIG. 5, which illustrates a flowchart of a process 50 in accordance with the fifth embodiment of the present invention. The process 50 is used to wake up a computer system operating in a standby mode safely, and includes following steps:

Step 500: start.

Step 502: determine whether there is RFID data to be received or not. If there is RFID data to be received, then go to step 504, otherwise, wait for the RFID data.

Step 504: receive the RFID data.

Step 506: determine whether the received RFID data has a specific authorization or not. If the RFID data has the specific authorization, then go to step 508, otherwise, go to step 510.

Step 508: wake the computer system up.

Step 510: keep the computer system in the standby mode.

Therefore, the process 50 tries to receive the RFID data before waking the computer system up. If the RFID data is received, then the process 50 determines whether the RFID data has authorization or not. If the RFID data has authorization, then the process 50 wakes up the operating system of the computer system to the previous state, and if the RFID data does not have authorization, meaning that the user is not a legal user, then the process 50 keeps the computer system in the standby mode, so as to prevent data stored in the computer system from being accessed.

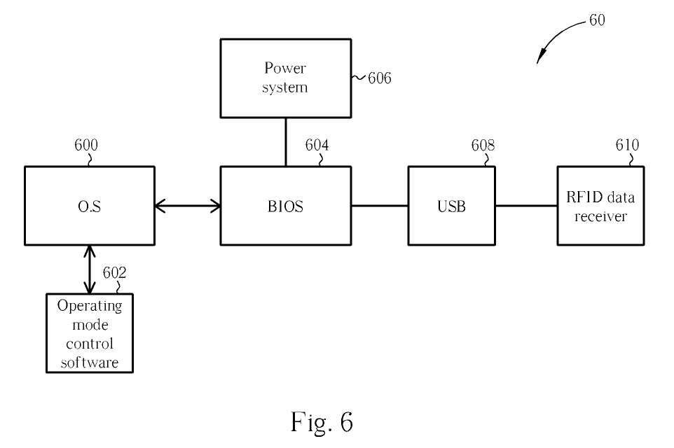

Before waking up the computer system operating in the standby mode, the process 50 determines whether the user is legal or not. Even if a username and corresponding password are stolen, the computer system still prevents data from being lost. In the present invention, the computer system can receive the RFID data through a universal serial bus (USB) port. For example, please refer to FIG. 6, which illustrates a block diagram of a computer system 60 capable of enhancing information security in accordance with the sixth embodiment of the present invention. The computer system 60 is used to implement the process 50, and includes an operating system 600, an operating mode control software 602, a BIOS 604, a power system 606, a USB 608, and a RFID data receiver 610. If the computer system 60 has not been used for a default time duration, the operating mode control software 602 changes the computer system 60 to the standby mode through the operating system 600, so as to save power. In this case, the BIOS 604 controls the power system 606 to decrease the power supply (decrease fan speed for example). After entering the standby mode, the BIOS 604 receives the RFID data through the USB 608 from the RFID data receiver 610, and the operating mode control software 602 determines whether to wake up the computer system 60 or to keep the computer system 60 in the standby mode according to the received RFID data.

In comparison, the prior art computer system only checks whether a username and a password are correct or not, so anyone can access the computer system if he/she gets the username and the password. The present invention performs identification works with a RFID system, which has advantages of contact-free reading, the capability of being updated, a large data capacity, the ability of being reused, high security, and a small volume. Therefore, users can wear RFID chips, so as to prevent data from being lost and maintain information security.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for enhancing information security of a computer system, for starting the computer system securely, the method comprising:
receiving radio frequency identification data when the computer system is switched on; and
controlling a power system of the computer system according to the radio frequency identification data.

2. The method of claim 1 further comprising enabling the power system of the computer system when the radio frequency identification data comprises a first authorization.

3. The method of claim 2, wherein the power system of the computer system is enabled by a basic input and output system of the computer system.

4. The method of claim 1 further comprising keeping the power system of the computer system off when the radio frequency identification data does not comprise the first authorization.

5. The method of claim 4, wherein the power system of the computer system is kept off by a basic input and output system of the computer system.

6. The method of claim 4 further comprising outputting an alarm signal through an output module of the computer system.

7. The method of claim 1, wherein the radio frequency identification data is received through a universal serial bus port when the computer system is switched on.

8. A computer system capable of enhancing information security comprising:
a basic input and output system for performing basic input and output functions of the computer system;
a power switch for signaling the basic input and output system for starting the computer system;
a power system coupled to the basic input and output system for outputting power;
a radio frequency identification data receiver for receiving radio frequency identification data; and
a decision module for controlling the power system through the basic input and output system according to the radio frequency identification data received by the radio frequency identification data receiver when the power switch is switched on.

9. The computer system of claim 8, wherein the radio frequency identification data receiver outputs the radio frequency identification to the basic input and output system through a universal serial bus.

10. The computer system of claim 8 further comprising an output module for outputting an alarm signal.

11. A method for enhancing information security of a computer system, for waking up a computer system operating in a standby mode, the method comprising:
receiving radio frequency identification data; and
determining an operating mode of the computer system according to the radio frequency identification data.

12. The method of claim 11 further comprising waking the computer system up when the radio frequency identification data comprises a first authorization.

13. The method of claim 12, wherein the computer system is woken up by software of the computer system.

14. The method of claim 11 further comprising keeping the computer system operating in the standby mode when the radio frequency identification data does not comprise the first authorization.

15. The method of claim 14, wherein the computer system is kept operating in the standby mode by software of the computer system.

16. The method of claim 11, wherein the radio frequency identification data is received through a universal serial bus port of the computer system.

17. A computer system capable of enhancing information security comprising:
a basic input and output system for performing basic input and output functions of the computer system;
a power system coupled to the basic input and output system for outputting power;
a radio frequency identification data receiver for receiving radio frequency identification data;
an operating system for performing functions of the computer system; and
an operating mode control software for controlling the power system and an operating mode of the operating system according the radio frequency identification data received by the radio frequency identification data receiver when the computer system is in a standby mode.

18. The computer system of claim 17, wherein the radio frequency identification data receiver outputs the radio frequency identification to the basic input and output system through a universal serial bus.
